(19) United States
(12) Patent Application Publication
(10) Pub. No.: US 2026/0233202 A1
(43) Pub. Date: Aug. 13, 2026

(54) ANTIFOULING MATERIALS BASED ON GLASSES WITH CATALYTIC SURFACE LAYERS

(71) Applicant: The Government of the United States of America, as represented by the Secretary of the Navy, Arlington, VA (US)

(72) Inventor: Kenan P. Fears, Alexandria, VA (US)

(73) Assignee: The Government of the United States of America, as represented by the Secretary of the Navy, Arlington, VA (US)

(21) Appl. No.: 19/535,126

(22) Filed: Feb. 10, 2026

Related U.S. Application Data
(60) Provisional application No. 63/756,373, filed on Feb. 10, 2025.

(51) Int. Cl. B01J 23/22; B01J 23/78; B01J 31/06; B01J 31/28; B01J 31/36; B01J 37/02; B01J 37/08

(52) U.S. Cl. CPC B01J 23/22; B01J 23/78; B01J 31/06; B01J 31/28; B01J 31/36; B01J 37/0219; B01J 37/088

(57) ABSTRACT

A glass composition having: an alkali metal oxide; boron oxide; and a transition metal oxide selected from vanadium oxide, iron oxide, titanium oxide, and manganese oxide. The glass may be made by melting a mixture of an alkali metal salt; boric acid; and a transition metal salt selected from vanadium salt, iron salt, titanium salt, and manganese salt to form a glass.

### REFERENCE TO RELATED APPLICATIONS

This application claims the benefit of U.S. Provisional Application No. 63/756,373, filed on Feb. 10, 2025. The provisional application and all other publications and patent documents referred to throughout this nonprovisional application are incorporated herein by reference.

### TECHNICAL FIELD

The present disclosure is generally related to antifouling materials.

### DESCRIPTION OF THE RELATED ART

Biofouling, the colonization of micro- and macroscopic organisms on engineered surfaces, presents a persistent challenge to commercial and recreational maritime operations. Ships residing in littoral regions often experience high fouling pressures due to low surface hydrodynamic flow rates and exposure to diverse fouling communities. Researchers have shown the formation of microbial biofilms on hulls adds a significant drag penalty, increasing power consumption by up to 10% [Schultz et al., Biofouling 2015]. In addition to the increased drag penalty imposed by the accumulation of hard foulers (e.g., barnacles and tubeworms), they are more difficult to remove if they reach maturity, increasing the cost to maintain assets and the frequency in which that must be cleaned to preserve operational readiness.

Historically, the maritime industry heavily relied on coatings that released a toxic biocide, tributyltin (TbT), to prevent biofouling on exposed surfaces. Due to the severe ecological impact of TbT, organotin compounds in marine coatings were globally banned in 2008. High copper content (>40 weight percent) antifouling coatings emerged as the predominant replacement for commercial and recreational applications. Since copper is an essential mineral, copper-based coatings were considered to be “friendlier” to the environment. Unfortunately, due to the heavy usage of these coatings, the bioaccumulation of copper in some marine and estuarine waters has reached levels that exceed clean water regulations, creating an urgent need for alternative solutions.

Self-polishing polymeric coatings that hydrolyze are a possible alternative, but currently still require the addition of biocides (e.g. copper/zinc pyrithione) to limit general biofouling, as do many resin-based systems. Tough polyurethanes with silicone surface films are effective fouling-release coatings—that is, they significantly reduce the force required to remove fouling organisms. However, they do not efficiently prevent hard fouling when the object is not in motion and coatings tend to be damaged by the growth of mature hard foulers.

It has previously been demonstrated that biodegradable glass windows deter biofouling through the release of ions naturally present in seawater [Fears et al., Adv. Mater. Interfaces. 2015; Fears et al., Philo. Trans. Roy. Soc. B 2019]. However, antifouling performance diminished if mature biofilms established on glass surfaces [Fears et al., Philo Trans Roy Soc B 2019].

### SUMMARY OF THE INVENTION

Disclosed herein is a composition comprising: an alkali metal oxide; boron oxide; and a transition metal oxide selected from vanadium oxide, iron oxide, titanium oxide, and manganese oxide.

Also disclosed herein is a method comprising: providing a composition and melting the composition to form a glass. The composition comprises: an alkali metal salt; boric acid; and a transition metal salt selected from vanadium salt, iron salt, titanium salt, and manganese salt.

### BRIEF DESCRIPTION OF DRAWINGS

A more complete appreciation will be readily obtained by reference to the following Description of the Example Embodiments and the accompanying drawings.

FIG. 1 shows the reaction process of aluminoborate glasses in seawater. Dissolution of the glass matrix leads to rapid precipitation of an amorphous reaction layer and subsequent formation of a nanocrystalline surface layer.

FIG. 2 shows V20 (left) and V0.2 (right) in scintillation vials containing an aqueous peroxide solution.

FIG. 3 shows untreated PVC (left), Cu0.5 (center), and V0.5 (right) panels after static immersion in a brackish estuarine environment for 4 weeks.

### DETAILED DESCRIPTION

In the following description, for purposes of explanation and not limitation, specific details are set forth in order to provide a thorough understanding of the present disclosure. However, it will be apparent to one skilled in the art that the present subject matter may be practiced in other embodiments that depart from these specific details. In other instances, detailed descriptions of well-known methods and devices are omitted so as to not obscure the present disclosure with unnecessary detail.

Disclosed herein are antifouling materials consisting of surface-active glasses, that is, glasses intentionally designed to degrade in aqueous environments. Glass compositions are detailed that resist marine fouling by one of the following modes of action, or a combination thereof: 1) erosion of material at the adhesive interface with fouling organisms, 2) release of ions that disrupt the settlement and/or adhesion of fouling organisms, or 3) formation of reaction layers that exhibit peroxidase-like activity and generate reactive oxygen species. The described glasses can be used as monoliths for applications, such as optical windows, or glass particles can be added to composite materials, such as high solids content coatings.

The glass composition has at least three components: an alkali metal oxide, boron oxide, and a transition metal oxide. Transition metal is vanadium, iron, titanium, or manganese. The alkali metal may be, for example, sodium.

Optionally, the composition may also comprise a network former selected from aluminum oxide and silicon oxide. Another optional component is a biocidal compound selected from copper oxide and silver oxide.

The composition may be made in the form of a powder. The particles of the powder need not be uniform throughout as to the relative amounts of the oxides. The surface of the particles may be structurally or compositionally different from the interior of the particles, and the particles may be hollow. The powder may be mixed with a polymeric matrix and formed into a coating. The polymeric matrix may be, for example, gum rosin.

The composition may be made by mixing the appropriate alkali metal and transition metal salts with boric acid and melting the mixture to form the glass. Such salts include, for example, sodium carbonate and vanadium sulfate. Any aluminum oxide, silicon oxide, copper oxide, or silver oxide is included in the oxide form.

Example mol % ranges for the oxides in the glass are provided in the following table, however amounts outside of these ranges may also be used.

| Oxide | Mol. % Range |
|---|---|
| Alkali metal oxide | 10-30 |
| Aluminum oxide | 0-30 |
| Boron oxide | 50-70 |
| Copper oxide | 0-10 |
| Iron oxide | 0-20 |
| Manganese oxide | 0-30 |
| Silica oxide | 0-20 |
| Silver oxide | 0-1 |
| Titanium oxide | 0-20 |
| Vanadium oxide | 0-70 |

Traditional melt batched glasses are formed by quenching molten metal oxides.

The constituents of these glasses fall into one of three categories: glass former, intermediate, and flux. Glass formers (e.g., SiO₂, GeO₂, B₂O₃, and P₂O₅) form a covalently crosslinked network of metal and oxygen atoms that constitute the bulk of the glass. Intermediates (e.g., TiO₂, Al₂O₃) and fluxes (e.g., alkali and alkaline earth oxides) serve as network modifiers. Fluxes dissociate in molten glass and weaken the glass network by breaking bridging oxygens (e.g., Si—O—Si) to create non-bridging oxygens (e.g., Si—O—) that electrostatically associate with interstitial cations (e.g., Na⁺, Ca²⁺). Intermediates can dissociate and disrupt the glass network or covalently bond to the glass network and modify its physical or chemical properties.

Surface-active glasses are a class of materials whose glass network is designed to undergo controlled hydrolysis in aqueous environments. These glasses have been used in a variety of biotechnological applications because they can deliver ions that stimulate cellular activity or inhibit microbial activity [Raja et al., ACS Biomater. Sci. Eng. 2022]. The delivery of fluxes (e.g., alkali metals) and modifiers (e.g., alkaline earth and divalent transition metals) is particularly efficient because these interstitial ions can readily exchange with H₃O⁺ ions in the surrounding media. The subsequent rate of hydrolysis of the glass network depends on the chemical durability of the glass matrix.

In prior reports [Fears et al., Adv. Mater. Interfaces 2015; Fears et al., Philo. Trans. Roy. Soc. B 2019], aluminoborate glasses were selected with the general molecular formula of 2 MO×2 Al₂O₃×6 B₂O₃, where MO represents a glass modifier(s). This glass composition was chosen because:
1) the hydrolysis rate of B—O—B is much faster than Si—O—Si
2) nonbridging oxygens are absent when the B₂O₃:Na₂O ratio is ≥3; BO₃ groups are converted to BO₄ groups to satisfy the charge of interstitial ions [VARSHNEYA, Fundamentals of inorganic glasses 2013]
3) Al acts as a network former with AlO₄ groups replacing BO₄ groups, increasing the chemical durability of the glass [Gresch et al., J. Non-Cryst. Solids 1976]
4) in the presence of the anionic species typically found in seawater (Cl⁻, CO₃²⁻, SO₄²⁻, OH⁻), the most thermodynamically favorable aluminum compound to form as the glass network dissolves is Al(OH)₃ (Kₛₚ=4.6×10⁻³³), which rapidly precipitates as a hydrogel limiting further dissolution of the glass matrix [Fears et al., Adv. Mater. Interfaces. 2015].

Since Al₂O₃ is serving an intermediate, the dissolution rate of the glass network, and by extension the ion release rate, can be readily adjusted by varying the Al₂O₃ content. Similarly, the dissolution rate of the glass can be modified by the addition of glass former less susceptible to hydrolytic degradation, such as SiO₂. In either case, reaction layers that rapidly precipitate on the surface limit the rate at which the underlying glass dissolves [Fears et al., Philo. Trans. Roy. Soc. B 2019].

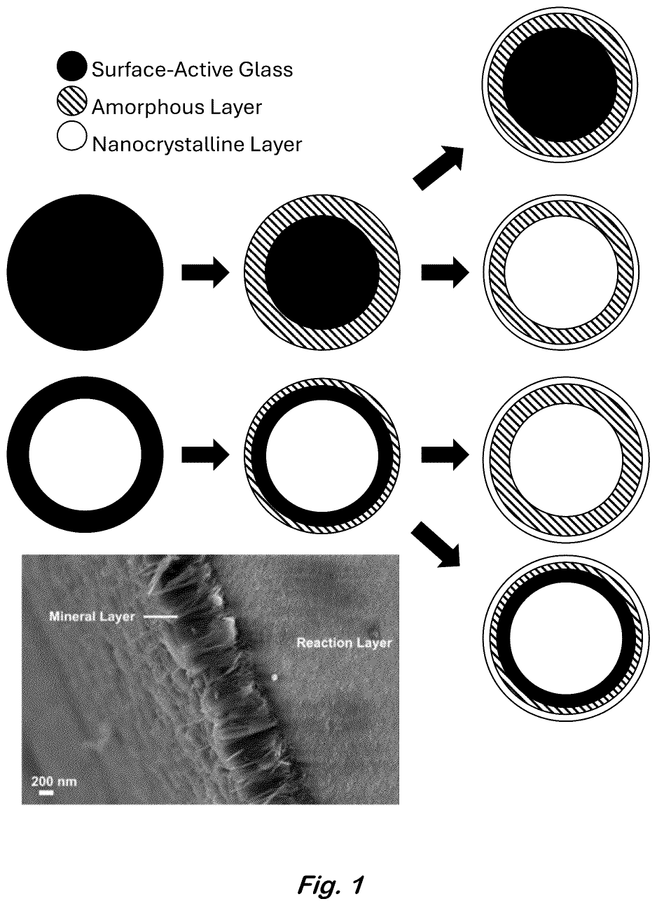

Manipulation of the chemical durability of the glass network also affords control of the morphology of particles of the described surface-active glasses. As shown in FIG. 1, the resulting particles can be solid or hollow depending on the durability of the glass network or the inclusion of voids during glass particle synthesis. The hollow particles offer weight reduction when used in composite materials or coatings.

The formation of a nanostructure is beneficial for the creation of chemically active materials. Certain inorganic nanoparticles, coined nanozymes, have been shown to exhibit enzyme-like activities [Peng et al., Adv. Mater. 2023]. Amongst the classes of enzymes mimicked are peroxidases, which have been linked to the prevention of biofilm formation on the surface of seaweeds [Wever et al., Environ. Sci. Technol. 1991]. Recently, Kişla et al. demonstrated nanotextured vanadium phosphate glass films prepared with thermionic vacuum arc plasma exhibit haloperoxidase activity, that is hypochlorous acid (HOCl) is formed in the presence of hydrogen peroxide and chloride ions [Kişla et al., J Non-Cryst. Solids 2024]. By doping surface-active borate glasses with vanadium, materials with nanostructured reaction layers that exhibit catalytic activity could more readily be formed than the methods described by Kişla et al.

The following examples are given to illustrate specific applications. These specific examples are not intended to limit the scope of the disclosure in this application.

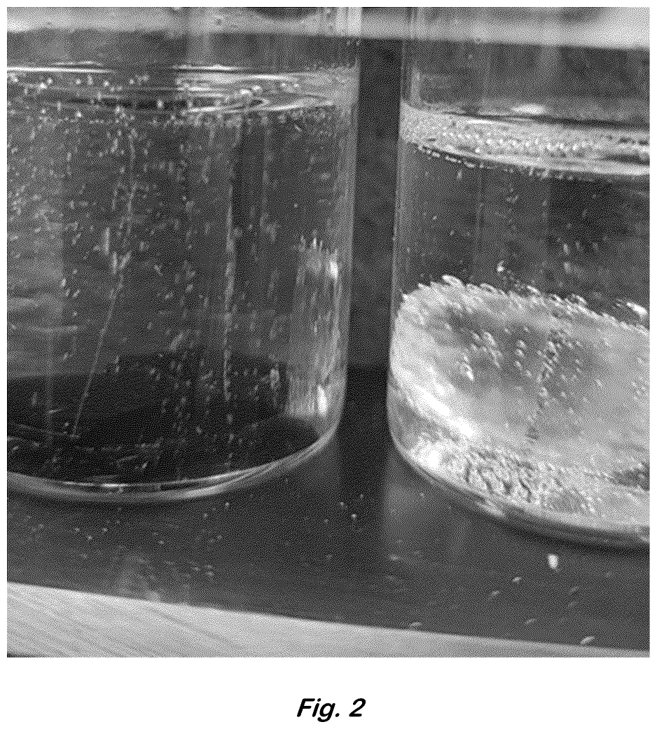

Example 1—A sodium vanadium borate glass (20.0 mol % Na₂O; 20.0 mol % VO₂; 60.0 mol % B₂O₃), denoted herein as V20, and a vanadium-doped sodium aluminoborate glass (0.2 mol % VO₂; 20.0 mol % Na₂O; 19.8 mol % Al₂O₃; 60.0 mol % B₂O₃), denoted herein as V0.2 were made. Glasses were prepared by batching the appropriate amounts of sodium carbonate, vandyl sulfate, aluminum oxide and boric acid in a platinum or fused quartz crucible and melting the batch at 1300° C. Ingots were formed by pouring the melts onto graphite slabs and annealing the ingots at 500° C. for several hours before allowing them to cool to room temperature. To test for catalytic activity, glass fragments were placed in scintillation vials filled with an aqueous peroxide solution, 1 part 30% (by volume) hydrogen peroxide in water and 9 parts artificial seawater (Instant Ocean). As shown in FIG. 2, placement of both glasses in the peroxide solution resulted in the generation of bubbles, indicating oxygen is being generated due to the reaction between hypochlorous acid and hydrogen peroxide. Due to the higher concentration of vanadium in V20, bubble formation was substantially quicker than V0.2, demonstrating activity can be tuned.

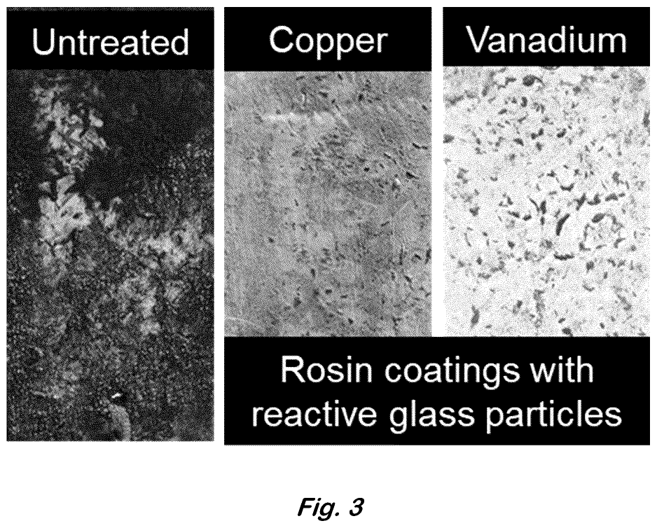

Example 2-A vanadium-doped sodium aluminoborate glass (0.5 mol % VO₂; 20.0 mol % Na₂O; 19.5 mol % Al₂O₃; 60.0 mol % B₂O₃), denoted herein as V0.5, and a copper-doped sodium aluminoborate glass (0.5 mol % CuO; 20.0 mol % Na₂O; 19.5 mol % Al₂O₃; 60.0 mol % B₂O₃), denoted herein as Cu0.5 were made. Glasses were prepared by batching the appropriate amounts of sodium carbonate, vandyl sulfate, copper oxide, aluminum oxide and boric acid in a fused quartz crucible and melting the batch at 1300° C. Molten glass was poured directly into a water column to form glass frit (~1-5 mm diameter). Glass frit was dried and ground in a mill to obtain glass powder, which was subsequently sieved. High solids paints were formulated by mixing 12 grams of glass powder (45-25 μm particles) into 10 grams of a pine gum rosin solution (80% by weight) in toluene. Paints were brushed onto polyvinyl chloride (PVC) panels and allowed to dry in open air for 14 days to ensure coatings were completely dry. To assess antifouling performance, panels were immersed in a brackish estuarine environment containing a diverse biofouling community. Biofouling was pervasive on control panels (untreated PVC) after 4 weeks of static immersion (FIG. 3). Biofouling was significantly reduced on rosin coatings containing Cu0.5 and V0.5, demonstrating the surface-active glasses impart antifouling activity even when embedded in a polymer matrix with low water solubility. Antifouling performance of the coatings would be improved by embedding reactive glass particles in a matrix that self-polishes at a faster rate (e.g., silyl acrylate based polymers), “refreshing” the surface substantially faster than rosin

Many modifications and variations are possible in light of the above teachings. It is therefore to be understood that the claimed subject matter may be practiced otherwise than as specifically described. Any reference to claim elements in the singular, e.g., using the articles “a”, “an”, “the”, or “said” is not construed as limiting the element to the singular.

What is claimed is:

1. A composition comprising:
an alkali metal oxide;
boron oxide; and
a transition metal oxide selected from vanadium oxide, iron oxide, titanium oxide, and manganese oxide.

2. The composition of claim 1, wherein the alkali metal oxide is sodium oxide.

3. The composition of claim 1, wherein the transition metal oxide is vanadium oxide.

4. The composition of claim 1, further comprising:
a network former selected from aluminum oxide and silicon oxide.

5. The composition of claim 4;
wherein the transition metal oxide is vanadium oxide; and
wherein the network former is aluminum oxide.

6. The composition of claim 1, further comprising:
a biocidal compound selected from copper oxide and silver oxide.

7. The composition of claim 6, further comprising:
a network former selected from aluminum oxide and silicon oxide.

8. The composition of claim 7;
wherein the biocidal compound is copper oxide; and
wherein the network former is aluminum oxide.

9. The composition of claim 1, wherein the composition is in the form of a powder.

10. A coating comprising:
the composition of claim 9; and
a polymeric matrix.

11. The coating of claim 10, wherein the polymeric matrix is gum rosin.

12. A method comprising:
providing a composition comprising:
an alkali metal salt;
boric acid; and
a transition metal salt selected from vanadium salt, iron salt, titanium salt, and manganese salt; and
melting the composition to form a glass.

13. The method of claim 12, wherein the alkali metal salt is sodium carbonate.

14. The method of claim 12, wherein the transition metal salt is vanadium sulfate.

15. The method of claim 12, wherein the composition further comprises:
a network former selected from aluminum oxide and silicon oxide.

16. The method of claim 15;
wherein the transition metal salt is vanadium sulfate; and
wherein the network former is aluminum oxide.

17. The method of claim 12, wherein the composition further comprises:
a biocidal compound selected from copper oxide and silver oxide.

18. The method of claim 17, wherein the composition further comprises:
a network former selected from aluminum oxide and silicon oxide.

19. The method of claim 18;
wherein the biocidal compound is copper oxide; and
wherein the network former is aluminum oxide.

20. The method of claim 12, wherein the glass is in the form of a powder.

21. The method of claim 20, further comprising:
combining the powder with a polymeric matrix to form a coating composition; and
applying the coating composition to a surface.

22. The method of claim 21, wherein the polymeric matrix is gum rosin.
